(19) United States
(12) Patent Application Publication
(10) Pub. No.: US 2019/0087403 A1
(43) Pub. Date: Mar. 21, 2019

(54) ONLINE SPELLING CORRECTION/PHRASE COMPLETION SYSTEM

(71) Applicant: Microsoft Technology Licensing, LLC, Redmond, WA (US)

(72) Inventors: Bo-June HSU, Woodinville, WA (US); Kuansan WANG, Bellevue, WA (US); Huizhong DUAN, Urbana, IL (US)

(21) Appl. No.: 16/197,277

(22) Filed: Nov. 20, 2018

Related U.S. Application Data
(63) Continuation of application No. 13/069,526, filed on Mar. 23, 2011, now abandoned.

(51) Int. Cl. G06F 17/27

(52) U.S. Cl. CPC G06F 17/273; G06F 17/276

(57) ABSTRACT

Online spelling correction/phrase completion is described herein. A computer-executable application receives a phrase prefix from a user, wherein the phrase prefix includes a first character sequence. A transformation probability is retrieved responsive to receipt of the phrase prefix, wherein the transformation probability indicates a probability that a second character sequence has been transformed into a first character sequence. A search is then executed over a trie to locate a most probable phrase completion based at least in part upon the transformation probability.

### RELATED APPLICATION

This application is a continuation of U.S. patent application Ser. No. 13/069,526, filed on Mar. 23, 2011, and entitled “ONLINE SPELLING CORRECTION/PHRASE COMPLETION SYSTEM”, the entirety of which is incorporated herein by reference.

### BACKGROUND

As data storage devices are becoming less expensive, an increasing amount of data is retained, wherein such data can be accessed through utilization of a search engine. Accordingly, search engine technology is frequently updated to satisfy information retrieval requests of a user. Moreover, as users continue to interact with search engines, such users become increasing adept at crafting queries that are likely to cause search results to be returned that satisfy informational requests of the users.

Conventionally, however, search engines have difficulty retrieving relevant results when a portion of a query includes a misspelled word. An analysis of search engine query logs finds that words in queries are often misspelled, and that there are various types of misspellings. For instance, some misspellings may be caused by “fat finger syndrome”, when a user accidentally depresses a key on a keyboard that is adjacent to a key that was intended to be depressed by the user. In another example, an issuer of a query may be unfamiliar with certain spelling rules, such as when to place the letter “i” before the letter “e” and when to place the letter “e” before the letter “i”. Other misspellings can be caused by the user typing too quickly, such as for instance, accidentally depressing a same letter twice, accidentally transposing two letters in a word, etc. Moreover, many users have difficulty in spelling words that originated in different languages.

Some search engines have been adapted to attempt to correct misspelled words in a query after an entirety of the query is received (e.g., after the issuer of the query depresses a “search” button). Furthermore, some search engines are configured to correct misspelled words in a query after the query in its entirety has been issued to a search engine, and then automatically undertake a search over an index utilizing the corrected query. Additionally, conventional search engines are configured with technology that provides query completion suggestions as the user types a query. These query completion suggestions often save the user time and angst by assisting the user in crafting a complete query that is based upon a query prefix that has been provided to the search engine. If a portion of the query prefix, however, includes a misspelled word, then the ability of conventional search engines to provide helpful query suggestions greatly decreases.

### SUMMARY

The following is a brief summary of subject matter that is described in greater detail herein. This summary is not intended to be limiting as to the scope of the claims.

Described herein are various technologies pertaining to online spelling correction/phrase completion, wherein online spelling correction refers to providing a spelling correction for a word or phrase as the user provides a phrase prefix to a computer-executable application. Pursuant to an example, online spelling correction/phrase completion can be undertaken at a search engine, wherein a query prefix (e.g., a portion of a query but not an entirety of the query) includes a potentially misspelled word, wherein such misspelled word can be identified and corrected as the user enters characters into the search engine, and wherein query completions (suggestions) that include a corrected word (properly spelled word) can be provided to the user. In another example, online spelling correction can be undertaken in a word processing application, in a web browser, can be included as a portion of an operating system, or may be included as a portion of another computer-executable application.

In connection with undertaking online spelling correction/phrase completion, a phrase prefix can be received from a user of a computing apparatus, where the phrase prefix includes a first character sequence that is potentially a misspelled portion of a word. For example, the user may provide the phrase prefix “get invl”. This phrase prefix includes the potentially misspelled character sequence “invl”, wherein an entirety of the phrase may be desired by the user to be “get involved with computers.” Aspects described herein pertain to identifying potential misspellings in character sequences of a phrase prefix, correcting potential misspellings, and thereafter providing a suggested complete phrase to a user.

Continuing with the example, responsive to receipt of the character sequence “vl”, a transformation probability can be retrieved from a first data structure in a computer readable data repository. For example, this transformation probability can be indicative of a probability that the character sequence “vol” has been (unintentionally) transformed into the character sequence proffered by the user (“vl”). While the character sequence “vl” includes two characters, and the character sequence “vol” includes three characters, it is to be understood that a character sequence can be a single character, zero characters, or multiple characters. Transformation probabilities can be computed in real-time (as phrase prefixes are received from the user), or pre-computed and retained in a data structure such as a hash table. Moreover, a transformation probability can be dependent upon previous transformation probabilities in a phrase. Therefore, for example, the transformation probability that the character sequence “vol” has been transformed into the character sequence “vl” by the user can be based at least in part upon the transformation probability that the character sequence “in” has been transformed into the identical character sequence “in”.

Subsequent to retrieving the transformation probability data, a search can be undertaken over a second data structure to locate at least one phrase completion, wherein the at least one phrase completion is located based at least in part upon the transformation probability data. Pursuant to an example, the second data structure may be a trie. The trie can comprise a plurality of nodes, wherein each node can represent a character or a null field (e.g., representing the end of the phrase). Two nodes connected by a path in the trie indicate a sequence of characters that are represented by the nodes. For example, a first node may represent the character “a”, a second node may represent the character “b”, and a path directly between these nodes represents the sequence of characters “ab”. Additionally, each node can have a score associated therewith that is indicative of a most probable phrase completion that includes such node. The score can be computed based at least in part upon, for instance, a number of occurrences of a word or phrase that have been observed with respect to a particular application. For example, the score can be indicative of a number of times a query has been received by a search engine (over some threshold window of time). Moreover, the search over the trie may be undertaken through utilization of an A* search algorithm or a modified A* search algorithm.

Based at least in part upon the search undertaken over the second data structure, a most probable word or phrase completion or plurality of most probable word or phrase completions can be provided to the user, wherein such word or phrase completions include corrections to potential misspellings included in the phrase prefix that has been provided to the computer-executable application. In the context of a search engine, through utilization of such technology, the search engine can quickly provide the user with query suggestions that include corrections to potential misspellings in a query prefix that has been proffered to the search engine by the user. The user may then choose one of the query suggestions, and the search engine can perform a search utilizing the query suggestion selected by the user.

Other aspects will be appreciated upon reading and understanding the attached figures and description.

### BRIEF DESCRIPTION OF THE DRAWINGS

FIG. 1 is a functional block diagram of an exemplary system that facilitates performing online spell correction/phrase completion responsive to receipt of a phrase prefix from a user.

FIG. 2 is an exemplary trie data structure.

FIG. 3 is a functional block diagram of an exemplary system that facilitates estimating, pruning, and smoothing, a transformation model.

FIG. 4 is a functional block diagram of an exemplary system that facilitates building a trie based at least in part upon data from a query log.

FIG. 5 is an exemplary graphical user interface pertaining to a search engine.

FIG. 6 illustrates an exemplary graphical user interface of a word processing application.

FIG. 7 is a flow diagram that illustrates an exemplary methodology for performing online spell correction/phrase completion responsive to receipt of a phrase prefix from a user.

FIG. 8 is a flow diagram that illustrates an exemplary methodology for outputting a query suggestion/completion with correction of potential misspellings received in a query prefix from a user.

FIG. 9 is an exemplary computing system

### DETAILED DESCRIPTION

Various technologies pertaining to online correction of a potentially misspelled word in a phrase prefix will now be described with reference to the drawings, where like reference numerals represent like elements throughout. In addition, several functional block diagrams of exemplary systems are illustrated and described herein for purposes of explanation; however, it is to be understood that functionality that is described as being carried out by certain system components may be performed by multiple components. Similarly, for instance, a component may be configured to perform functionality that is described as being carried out by multiple components. Additionally, as used herein, the term “exemplary” is intended to mean serving as an illustration or example of something, and is not intended to indicate a preference.

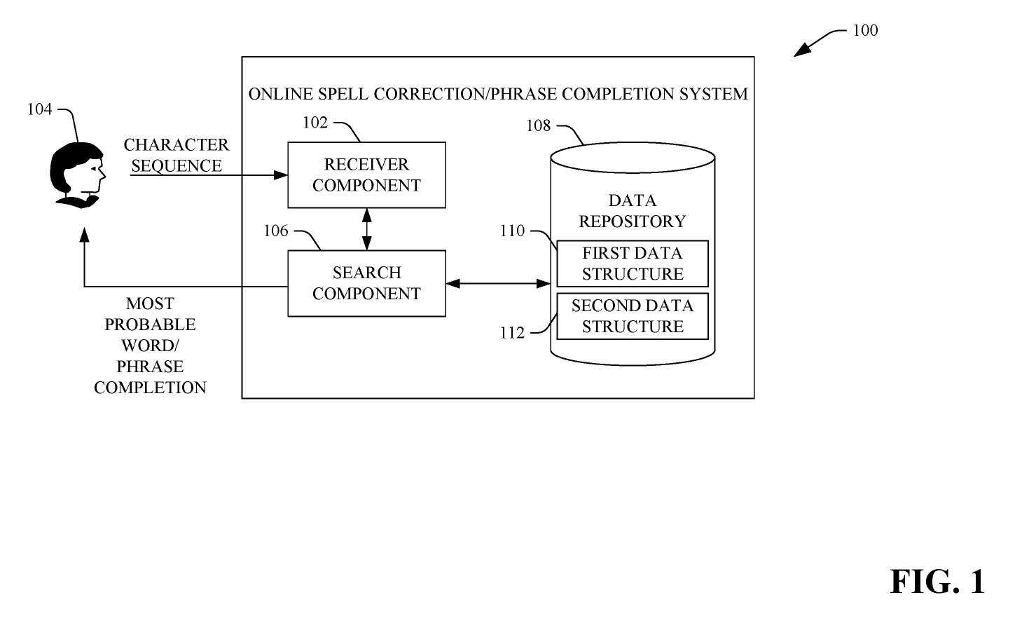

With reference now to FIG. 1, an exemplary online spell correction/phrase completion system 100 is illustrated, wherein the term “online spell correction//phrase completion” refers to proffering a phrase completion with a correction to a potentially misspelled word responsive to receipt of a phrase prefix from a user but prior to the user entering an entirety of the phrase. Pursuant to an example, the system 100 may be included in a computer executable application. Such application may be resident upon a server, such as a search engine, a word processing application that is hosted on a server, or other suitable server-side application. Moreover, the system 100 may be employed in a word processing application that is configured to execute on a client computing device, wherein the client computing device can be, but is not limited to, a desktop computer, a laptop computer, a portable computing device such as a tablet computer, a mobile telephone, or the like. Additionally, the system 100 may be utilized in connection with providing an online correction/completion of a potentially misspelled word for a single word, or may also be used in connection with providing an online correction/completion of a potentially misspelled word for an incomplete phrase. In addition, while the system 100 will be described herein as being configured to perform spelling corrections/phrase completions for phrases in a first language that include potentially misspelled words, it is to be understood that the technology described herein can be extended to assist the user in spelling correction/phrase completion for phrase prefixes in a first language that are desirably translated to a second language. For example, a user may wish to generate a phrase that includes Chinese characters. The user, however, may only have access to a keyboard that includes English characters. The technology described herein may be utilized to allow the user to type a phrase prefix utilizing English characters to approximate pronunciation of a particular Chinese word or phrase, and completed phrases in Chinese characters can be provided to the user responsive to the phrase prefix. Other applications will be readily comprehended by one skilled in the art.

The online spell correction/phrase completion system 100 comprises a receiver component 102 that receives a first character sequence from a user 104. For example, the first character sequence may be a portion of a prefix of a word or phrase that is provided by the user 104 to the computer executable application. For purposes of explanation, such computer executable application will be described herein as a search engine, but it is to be understood that the system 100 may be utilized in a variety of different applications. The first character sequence provided by the user 104 may be at least a portion of a potentially misspelled word. Moreover, the first character sequence may be a phrase or portion thereof that includes a potentially misspelled word, such as “getting invlv”. As will be described in greater detail herein, the first character sequence received by the receiver component 102 may be a single character, a null character, or multiple characters.

The online spell correction/phrase completion system 100 further comprises a search component 106 that is in communication with the receiver component 102. Responsive to the receiver component 102 receiving the first character sequence from the user 104, the search component 106 can access a data repository 108. The data repository 108 comprises a first data structure 110 and a second data structure 112. As will be described below, the first data structure 110 and the second data structure 112 can be pre-computed to allow for the search component 106 to efficiently search through such data structures 110 and 112. Alternatively, at least the first data structure 110 may be a model that is decoded in real-time (e.g., as characters in a phrase prefix proffered by the user are received).

The first data structure 110 can comprise or be configured to output a plurality of transformation probabilities that pertain to a plurality of character sequences. More specifically, the first data structure 110 includes a probability that a second character sequence, which may or may not be different from the character sequence received from the user 104, has been transformed (possibly unintentionally) into the first character sequence by the user 104. Thus, the first data structure 110 can include or output data that indicates that the probability that the user, either through mistake (fat finger syndrome or typing too quickly) or ignorance (unfamiliar with spelling rules, unfamiliar with a native language of a word) intended to type the second character sequence but instead typed the first character sequence. Additional detail pertaining to generating/learning the first data structure 110 is provided below. The second data structure 112 can comprise data indicative of a probability of a phrase, which can be determined based upon observed phrases provided to a computer-executable application, such as observed queries to a search engine. In an example, the data indicative of probability of the phrase can be based upon a particular phrase prefix. Therefore, for example, the second data structure 112 can include data indicative of a probability that the user 104 wishes to provide a computer executable application with the word “involved”. Pursuant to an example, the second data structure 112 may be in the form of a prefix tree or trie. Alternatively, the second data structure 112 may be in the form of an n-gram language model. In still yet another example, the second data structure may be in the form of a relational database, wherein probabilities of phrase completions are indexed by phrase prefixes. Of course, other data structures are contemplated by the inventors and are intended to fall under the scope of the hereto-appended claims.

The search component 106 can perform a search over the second data structure 112, wherein the second data structure comprises word or phrase completions, and wherein such word or phrase completions have a probability assigned thereto. For instance, the search component 106 may utilize an A* search or a modified A* search algorithm in connection with searching over the possible word or phrase completions in the second data structure 112. An exemplary modified A* search algorithm that can be employed by the search component 106 is described below. The search component 106 can retrieve at least one most probable word or phrase completions from the plurality of possible word or phrase completions in the second data structure 112 based at least in part upon the translation probability between the first character sequence and the second character sequence retrieved from the first data structure 110. The search component 106 may then output at least the most probable phrase completion to the user 104 as a suggested phrase completion, wherein the suggested phrase completion includes a correction to a potentially misspelled word. Accordingly, if the phrase prefix provided by the user 104 includes a potentially misspelled word, the most probable word/phrase completion provided by the search component 106 will include a correction of such potentially misspelled word, as well as a most likely phrase completion that includes the correctly spelled word.

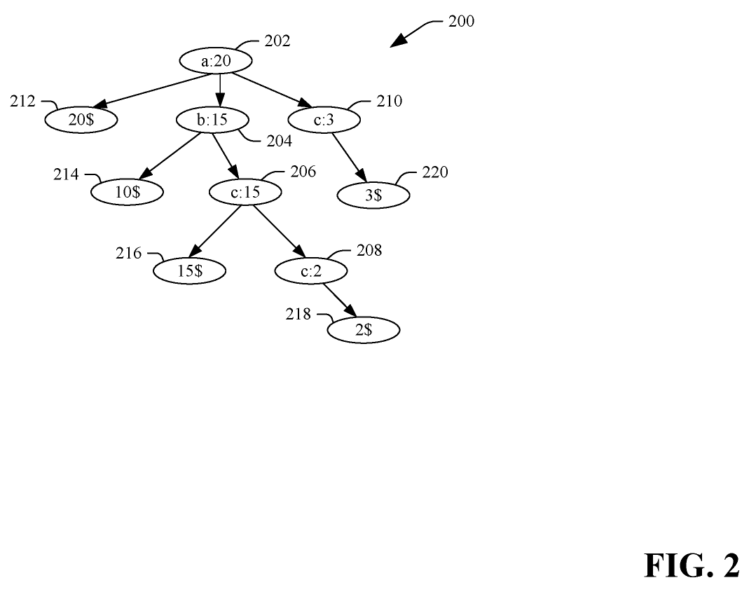

With reference now to FIG. 2 an exemplary trie 200 that can be searched over by the search component 106 in connection with providing a threshold number of most probable word or phrase completions with corrected spellings is illustrated. The trie 200 comprises a first intermediate node 202, which represents a first character that may be proffered by a user when entering a query to a search engine. The trie 200 further comprises a plurality of other intermediate nodes 204, 206, 208, and 210, which are representative of a sequence characters that begin with the character represented by the first intermediate node 202. For instance, the intermediate node 204 can represent the character sequence “ab”. The intermediate 206 represents the character sequence “abc”, and the intermediate node 208 represents the character sequence “abcc”. Similarly, the intermediate node 210 represents the character sequence “ac”.

The trie further comprises a plurality of leaf nodes 212, 214, 216, 218 and 220. The leaf nodes 212-220 represent query completions that have been observed or hypothesized. For example, the leaf node 212 indicates that users have proffered the query “a”. The leaf node 214 indicates that users have proffered the query “ab”. Similarly, the leaf node 216 indicates that users have set forth the query “abc”, and the leaf node 218 indicates that users have set forth a query “abcc”. Finally, the leaf node 220 indicates that users have set forth the query “ac”. For instance, these queries can be observed in a query log of a search engine. Each of the leaf nodes 212-220 may have a value assigned thereto that indicates a number of occurrences of the query represented by the leaf nodes 212-220 in a query log of a search engine. Additionally or alternatively, the values assigned to the leaf nodes 212-220 can be indicate of probability of the phrase completion from a particular intermediate node. Again, the trie 200 has been described with respect to query completions, but it is understood that the trie 200 may represent words in a dictionary utilized in a word processing application, or the like. Each of the nodes 202-210 can have a value assigned thereto that is indicative of a most probable path beneath such intermediate node. For example, the node 202 may have a value of 20 assigned thereto, since the leaf node 212 has a score of 20 assigned thereto, and such value is higher than values assigned to other leaf nodes that can be reached by way of the intermediate node 202. Similarly, the intermediate node 204 can have a value of 15 assigned thereto, since the value of the leaf node at 216 is the highest value assigned to leaf nodes that can be reached by way of the intermediate node 204.

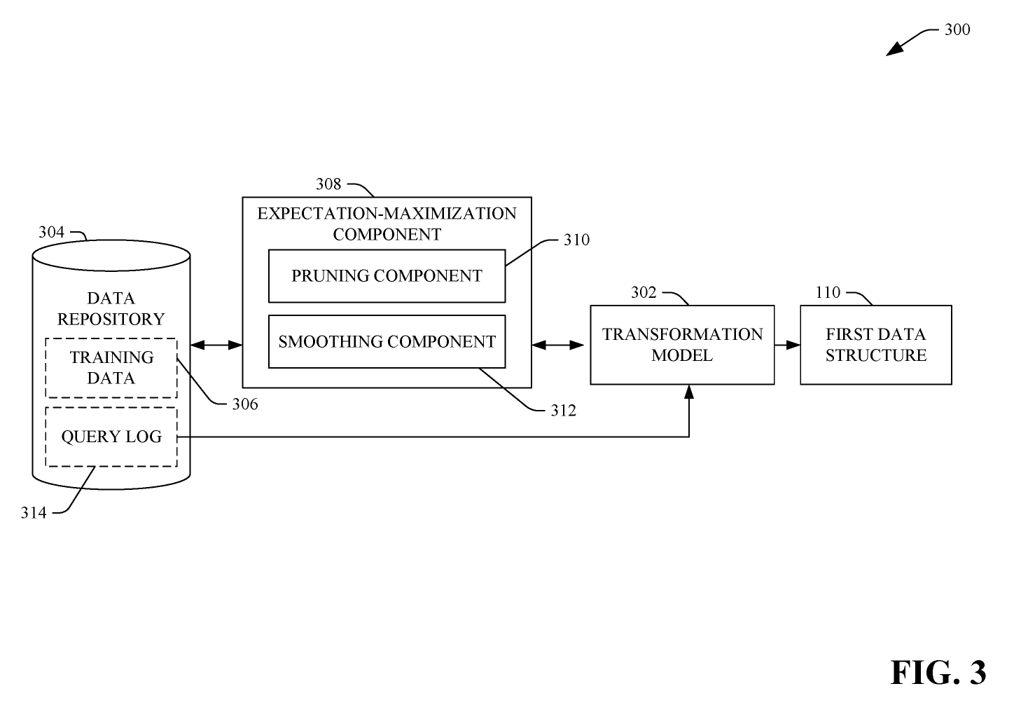

With reference now to FIG. 3, an exemplary system 300 that facilitates building the first data structure 110 for utilization in connection with performing online spell correction/phrase completion is illustrated. In off-line spelling correction, wherein an entirety of a query received, it is desirable to find a correctly spelled query ĉ with the highest probability of yielding the potentially misspelled input query q. By applying Bayes rule, this task can be alternatively expressed as follows:

$$\hat{c} = {argmax}_{c} p ( c \vert q ) = {argmax}_{c} p ( q \vert c ) p ( c ) \qquad ( 1 )$$

In this noisy channel model formulation, p(c) is a query language model that describes the prior probability of c as the intended user query. p(q|c)=p(c→q) is the transformation model that represents the probability of observing the query q when the original user intent is to enter the query c.

For online spelling correction, the prefix of the query q̅ is received, wherein such prefix of the query is a portion of the potentially misspelled input query q. Accordingly, the objective of online spelling correction is to locate the correctly spelled query ĉ that maximizes the probability of yielding any query q that extends the given partial query q̅. More formally, it is desirable to locate the following:

$$\hat{c} = {argmax}_{c , q : q = \overline{q} …} p ( c \vert q ) = {argmax}_{c , q : q = \overline{q} …} p ( q \vert c ) p ( c ) \qquad ( 2 )$$

where q=q̅ . . . denotes that q̅ is a prefix of q. In such a formulation, off-line spelling correction can be viewed as a constrained special case of the more generic online spelling correction.

The system 300 facilitates learning a transformation model 302 that is an estimate of the aforementioned generative model. The transformation model 302 is similar to the joint sequence model for grapheme to phoneme conversion in speech recognition, as described in the following publication: M. Bisani and H. Ney. “Joint-Sequence Models for Grapheme-to-Phoneme Conversion. Speech Communication, Vol. 50. 2008, the entirety of which is incorporated herein by reference.

The system 300 comprises a data repository 304 that includes training data 306. For instance, the training data 306 may include the following labeled data: word pairs, wherein a first word in a word pair is a misspelling of a word and a second word in the word pair is the properly spelled word, and labeled character sequences in each word in the word pair, wherein such words are broken into non-overlapping character sequences, and wherein character sequences between words in the word pair are mapped to one another. It can be ascertained, however, that obtaining such training data, particularly on a large scale, may be costly. Therefore, in another example, the training data 306 may include word pairs, wherein a word pair includes a misspelled word and a corresponding properly spelled word. This training data 306 can be acquired from a query log of a search engine, wherein a user first proffers a misspelled word as a portion of a query and thereafter corrects such word by selecting a query suggested by the search engine. Thereafter, and as will be described below, an expectation maximization algorithm can be executed over the training data 306 to learn the aforementioned character sequences between word pairs, and thus learn the transformation model 302. Such an expectation maximization algorithm is represented in FIG. 3 by an expectation-maximization component 308. The expectation-maximization component 308 can include a pruning component 310 that can prune the transformation model 302, and can further include a smoothing component 312 that can smooth such model 302. Thereafter, the transformation model 302 may be provided previously observed query prefixes to generate the first data structure 110. Alternatively, the pruned, smoothed transformation model 302 may itself be the first data structure 110, and can be operative to output, in real-time, transformation probabilities pertaining to one or more character sequences in a query prefix set forth by a user.

In more detail, the transformation model 302 can be defined as follows: a transformation from an intended query c to the observed query q can be decomposed as a sequence of substring transformation units, which are referred to herein as transfemes or character sequences. For example, the transformation “britney” to “britny” can be segmented into the transfeme sequence {br→br,i→t→t,ney→ny}, where only the last transfeme ney→ny, involves a correction. Given a sequence of transfemes s=t₁t₂, . . . , tₗ_{^{s}}, the probability of the sequence can be expanded utilizing the chain rule. As there are multiple manners to segment a transformation, in general the transformation probability p(c→q) can be modeled as a sum of all possible segmentations. This can be represented as follows:

p(c→q)Σ_{s∈S(c→q)}p(s)=Σ_{s∈S(c→q)}Π_{i∈[1,l}_{^{s}}_{]}p(tᵢ|t₁, . . . ,tᵢ₋₁), (3)

where S(c→q) is the set of all possible joint segmentations of c and q. Further, by applying the Markov assumption that a transfeme only depends on the previous M−1 transfemes, similar to an n-gram language model, the following can be obtained

p(c→q)=Σ_{s∈S(c→q)}Π_{i∈[1,l}_{^{s}}_{]}p(tᵢ|t_{i-M+1}, . . . ,tᵢ₋₁) (4)

The length of a transfeme t=cₜ→qₜ can be defined as follows:

|t|=max{|cₜ|,|qₜ|} (5)

In general, a transfeme can be arbitrarily long. To constrain the complexity of the resulting transformation model 302, a maximum length of a transfeme can be limited to L. With both n-gram approximation and character sequence length constraint, a transformation model 302 with parameters M and L can be obtained:

$$p ( c \to q ) = {{\sum }_{s ∈ S ( c \to q ) :}^{ }}_{∀ t ∈ s , \vert t \vert \leq L} {\prod }_{i ∈ [ 1 , {l}^{s} ]}^{ } p ( {t}_{i} \vert {t}_{i - M + 1} , … , {t}_{i - 1} ) \qquad ( 6 )$$

In the special case of M=1 and L=1, the transformation model 302 degenerates to a model similar to weighted edit distance. With M=1, it can be assumed that the transfemes are generated independently of one another. As each transfeme may include substrings of at most one character with L=1, the standard Levenshtein edit operations can be modeled: insertions: ε→α; deletions α→ε; and substitutions α→β, where ε denotes an empty string. Unlike many edit distance models, however, the weights in the transformational model 302 represent normalized probabilities estimated from data, not just arbitrary score penalties. Accordingly, such transformation model 302 not only captures the underlying patterns of spelling errors, but also allows for comparison of the probabilities of different completion suggestions in a mathematically principled manner.

When L=1, transpositions are penalized twice even though a transposition occurs as easily as other edit operations. Similarly, phonetic spelling errors, such as ph→f, often involve multiple characters. Modeling these character sequences as single character edit operations not only over-penalizes the transformation, but may also pollute the model as it increases the probabilities of edit operations such as p→f that would otherwise have very low probabilities. By increasing L, the allowable length of the transfemes is increased. Accordingly, the resultant transformation model 302 is able to capture more meaningful transformation units and reduce probability contamination that results from decomposing intuitively atomic substring transformations.

Rather than increasing L or in addition to increasing L, the modeling of errors spanning multiple characters can be improved by increasing M, the number of transfemes on which the model probabilities are conditioned. In an example, the character sequence “ie” is often transposed as “ei”. A unigram model of (M=1) is not able to express such an error. A bigram model (M=2) captures this pattern by assigning a higher probability to the character sequence e→i when following i→e. A trigram model (M=3) can further identify exceptions to this pattern, such as when the characters “ie” or “ei” are preceded by the letter “c”, as “cei” is more common than “cie”.

As mentioned previously, to learn patterns of spelling errors, a parallel corpus of input and output word pairs is desired. The input represents the intended word with corrected spelling while the output corresponds to a potentially misspelled transformation of the input. Additionally, such data may be pre-segmented into the aforementioned transfemes, in which case the transformation model 302 can be derived directly utilizing a maximum likelihood estimation algorithm. As noted above, however, such labeled training data may be too costly to obtain in a large scale. Thus, the training data 306 may include input and output word pairs that are labeled, but such word pairs are not segmented. The expectation-maximization component 308 can be utilized to estimate the parameters of the transformation model 302 from partially observed data.

If the training data 306 comprises a set of observed training pairs O={O^{k}}, where O^{k}=c^{k}→q^{k}, the log likelihood of the training data 306 can be written as follows:

log [symbol] (Θ;O)=Σₖ log p(c^{k}→q^{k}|Θ)=Σₖ log Σₛ_{^{k}}_{∈S(O}_{^{k}}₎p(s^{k}|Θ), (7)

where Θ={p(t|t_{-M+1}, . . . , t₋₁)} is a set of model parameters. s^{k}=t₁^{k}t₂^{k}, . . . , tₗ_{^{s}}^{k}, the joint segmentation of each training pair c^{k}→q^{k} into a sequence of character sequences, is the unobserved variable. By applying an expectation maximization algorithm, the parameter set Θ can be located that maximizes the log likelihood.

For M=1 and L=1, for each transfeme of length up to 1 is generated independently, the following update formulas can be derived:

$$\begin{matrix}p ( s ; Θ ) = {\prod }_{i ∈ [ 1 , {l}^{s} ]}^{ } p ( {t}_{i} ; Θ ) & ( 8 ) \\ e ( t ; Θ ) = {\sum }_{k} {\sum }_{{s}^{k} ∈ S ( {O}^{k} )} \frac{p ( {s}^{k} ; Θ )}{{\sum }_{{s}^{′} ∈ S ( {O}^{k} )} p ( {s}^{′} ; Θ )} \# ( t , {s}^{k} ) & ( 9 ) \\ p ( t ; {Θ}^{′} ) = \frac{e ( t ; Θ )}{{\sum }_{{t}^{′}} e ( {t}^{′} ; Θ )} & ( 10 )\end{matrix}$$

where #(t, s) is the count of transfeme t in the segmentation sequence s, e(t; Θ) is the expected partial account of the transfeme t with respect to the transformation model Θ, and Θ′ is the updated model. e(t; Θ), also known as the evidence for t, can be computed efficiently using a forward-backward algorithm.

The expectation maximization training algorithm represented by the expectation mechanization component 308 can be extended to higher order transformation models (M>1), where the probability of each transfeme may depend on the previous M−1 transfemes. Other than having to take into account the transfeme history context when accumulating partial counts, the general expectation maximization procedure is essentially the same. Specifically, the following can be obtained:

$$\begin{matrix}p ( s ; Θ ) = {\prod }_{i ∈ [ 1 , {l}^{s} ]}^{ } p ( {t}_{i} \vert {t}_{i - M + 1}^{i - 1} ; Θ ) & ( 11 ) \\ e ( t , h ; Θ ) = {\sum }_{k} {\sum }_{{s}^{k} ∈ S ( {O}^{k} )} \frac{p ( {s}^{k} ; Θ )}{{\sum }_{{s}^{′} ∈ S ( {O}^{k} )} p ( {s}^{′} ; Θ )} \# ( t , h , {s}^{k} ) & ( 12 ) \\ p ( t \vert h ; {Θ}^{′} ) = \frac{e ( t , h ; Θ )}{{\sum }_{{t}^{′}} e ( {t}^{′} , h ; Θ )} , & ( 13 )\end{matrix}$$

where h is a transfeme sequence representing the history context, and #(t, h, s) is the occurrence count of transfeme t following the context h in the segmentation sequence s. Although more complicated, e(t, h; Θ) the evidence for t in the context of h can still be computed efficiently using the forward backward algorithm.

As the number of model parameters increases with M, the model parameters can be initialized using the convergence of values from the lower order model to achieve faster convergence. Specifically, the following algorithm can be employed:

p(t|h^{M};Θ^{M})≡p(t|h^{M-1};Θ^{M-1}) (14)

where h^{M} is a sequence of M−1 character sequences representing the context, and h^{M-1} is h^{M} without the oldest context character transfeme. Extending the training procedure to L>1 further complicates the forward-backward computation, but the general form of the expectation maximization algorithm can remain the same.

When the model parameters M and L are increased in the transformation model 302, the number of potential parameters in the transformation model 302 increases exponentially. The pruning component 310 may be utilized to prune some of such potential parameters to reduce complexity of the transformation model 302. For example, assuming an alphabet size of 50, a M=1, L=1 model includes (50+1)² parameters, as each component in the t=cₜ→qₜ can take on any of the 50 symbols or ε. A M=3, L=2 model, however, may contain up to (50²+50+1)^{2.3}≈2.8×10²⁰ parameters. Although most parameters are not observed in the data, model pruning techniques can be beneficial to reduce overall search space during both training and decoding, and to reduce overfitting, as infrequent transfeme n-grams are likely to be noise.

Two exemplary pruning strategies that can be utilized by the pruning component 310 when pruning parameters of the transformation model 302 are described herein. In a first example, the pruning component 310 can remove transfeme n-grams with expected partial counts below a threshold τ^{e}. Additionally, the pruning component 310 can remove transfeme n-grams with conditional probabilities below a threshold τ^{p}. The thresholds can be tuned against a held-out development set. By filtering out transfemes with low confidence, the number of active parameters in the transformation model 302 can be significantly reduced, thereby speeding up running time of training and decoding the transformation model 302. While the pruning component 310 has been described as utilizing the two aforementioned pruning strategies, it is understood that a variety of other pruning techniques may be utilized to prune parameters of the transformation model 302, and such techniques are intended to fall within the scope of the hereto-appended claims.

As with any maximum likelihood estimation techniques, the expectation-maximization component 308 may overfit the training data 306 when the number of model parameters is large, for example, when M>1. The standard technique in n-gram language modeling to address this problem is to apply smoothing when computing the conditional probabilities. Accordingly, the smoothing component 312 can be utilized to smooth the transformation model 302, wherein the smoothing component 312 can utilize for instance, Jelinek Mercer (JM), absolute discounting (AD), or some other suitable technique when performing model smoothing.

In JM smoothing, the probability of a character sequence is given by the linear interpolation of its maximum likelihood estimation at order M (using partial counts), and its smoothed probability from a lower order distribution:

$${p}^{JM} ( t \vert {h}^{M} ) = ( 1 - α ) \frac{e ( t , {h}^{M} )}{{\sum }_{{t}^{′}} e ( {t}^{′} , {h}^{M} )} + α {p}^{JM} ( t \vert {h}^{M - 1} ) \qquad ( 15 )$$

where α∈(0,1) is the linear interpolation parameter. It can be noted that p^{JM}(t|h^{M}) and p^{JM}(t|h^{M-1}) are probabilities from different distributions within the same model. That is, in computing the M-gram model, the partial counts and probabilities for all lower order m-grams can also be computed, where m≤M.

AD smoothing operates by discounting the partial counts of the transfemes. The removed probability mass is then redistributed to the lower order model:

$${p}^{AD} ( t \vert {h}^{M} ) = \frac{max ( e ( t , {h}^{M} ) - d , 0 )}{{\sum }_{{t}^{′}} e ( {t}^{′} , {h}^{M} )} + α ( {h}^{M} ) {p}^{AD} ( t \vert {h}^{M - 1} ) \qquad ( 16 )$$

where d is the discount and α(h^{M}) is computed such that Σₜp^{AD}(t|h^{M})=1. Since the partial count e(t, h^{M}) can be arbitrarily small, it may not be possible to choose a value of d such that e(t, h^{M}) will always be larger than d. Consequently, the smoothing component 312 can trim the model if e(t, h^{M})≤d. For these pruning techniques, parameters can be tuned on a held-out development set. While a few exemplary techniques for smoothing the transformation model 302 have been described, it is to be understood that various other techniques may be employed to smooth such model 302, and these techniques are contemplated by the inventors.

It is to be understood that when training the transformation model 302 from the training data 306 that only includes word correction pairs, the resulting transformation model 302 may be likely to over-correct. Accordingly, the training data 306 may also include word pairs wherein, both the input and output word are correctly spelled (e.g., the input and output word are the same). Accordingly, the training data 306 can include a concatenation of two different data sets. A first data set that includes word pairs where the input is a correctly spelled word and the output is the word incorrectly spelled, and a second data set that includes word pairs where both the input and output are correctly spelled. Another technique is to train two separate transformation models from two different data sets. In other words, a first transformation model can be trained utilizing correct/incorrect word pairs while the second transformation model can be trained utilizing correct word pairs. It can be ascertained that the model trained from correctly spelled words will only assign non-zero probabilities to transfemes with identical input and output, as all the transformation pairs are identical. In an example, the two models can be linear interpolated as the final transformation model 302 as follows:

p(t)=(1−λ)p(t;Θ^{misspelled})+λp(t;Θ^{identical}) (17)

This approach can be referred to as model mixture, where each transfeme can be viewed as being probabilistically generated from one of the two distributions according to the interpolation factor λ. As with other modeling parameters, Δ can be tuned on a held out development set. While some exemplary approaches for addressing the tendency of the transformation model 302 to over-correct have been described above, other approaches for addressing such tendency are also contemplated.

Subsequent to the transformation model 302 being trained, such transformation model 302 can be provided with queries proffered by users 308 in the query log 314 of a search engine. The transformation model 302, for various queries in the query log 314, can segment such queries into transfemes and compute transformation probabilities for transfemes in the query to other transfemes. In this case, the transformation model 302 is utilized to pre-compute first data structure 110, which can include transformation probabilities corresponding to various transfemes. Alternatively, the transformation model 302 itself may be the first data structure 110.

While the transformation model 302 has been described above as being learned through utilization of queries in a query log, it is to be understood that the transformation model 302 can be trained for particular applications. For instance, soft keyboards (e.g., keyboards on touch-sensitive devices such as tablet computing devices and portable telephones) have become increasingly popular. These keyboards, however, may have an unconventional setup, due to lack of available space. This may cause spelling errors to occur that are different from spelling errors that commonly occur on a QWERTY keyboard. Thus, the transformation model 302 can be trained utilizing data pertaining to such soft keyboard. In another example, portable telephones are often equipped with specialized keyboards for texting, wherein “fat finger syndrome”, for example, may cause different types of spelling errors to occur. Again, the transformation model 302 can be trained based upon the specific keyboard layout. In addition, if sufficient data is acquired, the transformation model 302 can be trained based upon observed spelling of a particular user for a certain keyboard/application. Moreover, such a trained transformation model 302 can be utilized to automatically select a key when the input of what the user actually selected is “fuzzy”. For instance, the user input may be proximate to an intersection of four keys. Transformation probabilities output by the transformation model 302 pertaining to the input and possible transformations can be utilized to accurately estimate the intent of the user in real-time.

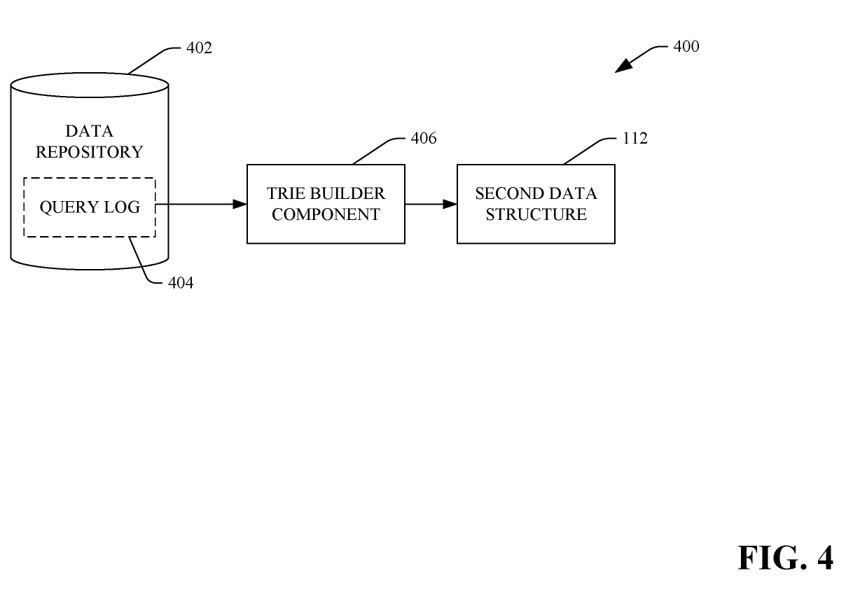

Turning now to FIG. 4, an exemplary system 400 that facilitates building the second data structure 112 is illustrated. As mentioned previously, the second data structure 112 may be a trie. The system 400 comprises a data repository 402 that includes a query log 404. A tried builder component 406 can receive the query log 404 and generate the second data structure 112 based at least in part upon queries in the query log 404. For example, the trie builder component 406 can, for queries that include correctly spelled words, segment the query into individual characters. Nodes can be built that represent individual characters in queries in the query log 404, and paths can be generated between characters that are sequentially arranged. As noted above, each intermediate node can be assigned a value that is indicative of a most commonly occurring or probable query sequence that extends from such intermediate node.

Returning again to FIG. 1, additional detail pertaining to operation of the search component 106 is provided. The receiver component 102 can receive a first character sequence (transfeme) from the user 104, and the search component 106 can access the first data structure 110 and the second data structure 112 responsive to receiving the first character sequence. The search component 106 can utilize a modified A* search algorithm to locate at least one most probable word/phrase completion for the phrase prefix q̅. Each intermediate search path can be represented as a quadruplet <Pos, Node, Hist, Prob> corresponding to the current position in the phrase prefix q, the current node in the trie T, the transformation history Hist up to this point, and the probability Prob of a particular search path, respectively. An exemplary search algorithm that can be utilized by the search component 106 is shown below.

Input: Query trieT, transformation model Θ, integer k, query prefix q̅
Output: Top k completion suggestions of q̅

| | |
|---|---|
| A | List l = new List( ) |
| B | PriorityQueuepq = new PriorityQueue( ) |
| C | pq.Enqueue(new Path(0, T.Root, [ ], 1)) |
| D | while (!pq.Empty( )) |
| E | Path π = pq.Dequeue( ) |
| F | if (π.Pos<\|q̅\|) // Tranform input query |
| G | foreach (Transfeme t in GetTransformations(π, q̅, T, Θ)) |
| H | int i = π.Pos + t.Output.Length |
| I | Node n = π.Node.FindDescendant(t.Input) |
| J | History h = π.Hist + t |
| K | Probp = π.Prob × (n.Prob / π.Node.Prob) × |
| | P(t, π.Hist; Θ) |
| L | pq.Enqueue(new Path(i, n, h, p)) |
| M | else // Extend input query |
| N | if (π.Node.IsLeaf( )) |
| O | l.Add(π.Node.Query) |
| P | if (l.Count ≥ k) |
| Q | return l |
| R | else |
| S | foreach (Transfeme t in GetExtensions(π, T, Θ)) |
| T | inti = π.Pos + t.Output.Length |
| U | Node n = π.Node.FindDescendant(t.Input) |
| V | History h = π.Hist + t |
| W | Probp = π.Prob × (π.Prob / π.Node.Prob) |
| X | pq.Enqueue(new Path(i, n, h, p)) |
| Y | return l |

This exemplary algorithm works by maintaining a priority queue of intermediate search paths ranked by decreasing probabilities. The queue can be initialized with the initial path <0, T.Root, [ ], 1> as shown in line C. While there is still a path on the queue, such path can be de-queued and reviewed to ascertain whether there are still characters unaccounted for in the input phrase prefix q̅ (line F). If so, all transfeme expansions that transform substrings starting from the current node in the trie to substrings yet accounted for in the phrase prefix q̅ can be iterated over (line G). For each character sequence expansion, a corresponding path can be added to the trie (line L). The probability of the path can be updated to include adjustments to the heuristic future score and the probability of the transfeme given the previous history (line K).

As the search component 106 expands the search path, a point will eventually be reached when all characters in the input phrase prefix q̅ have been consumed. The first path in the search performed by the search component 106 that meets this criterion represents a partial correction to the partial input phrase q̅. At this point, the search transitions from correcting potential errors in the partial input to extending the partial correction to complete phrases (queries). Accordingly, when this occurs (line M), if the path is associated with a leaf node in the trie (line N), indicating that the search component 106 has reached the end of a complete phrase, the corresponding phrase can be added to the suggestion list (line O) and returned if a sufficient number of suggestions exist (line P). Otherwise, all transfemes that extend from the current node (line S) are iterated over and are added to the priority queue (line X). As the transformation score is not affected by extensions to the partial query, the score is updated to reflect alterations in the heuristic future score (line W). When there are no further search paths to expand, the current list of correction completions can be returned (line Y).

The heuristic future score utilized by the search component 106 is a modified A* algorithm, as applied in lines K and W, is the probability value stored with each node in the trie. As this value represents the largest probability among all phrases reachable from this path, it is an admissible heuristic value that guarantees that the algorithm will indeed find the top suggestions.

A problem with such heuristic function is that it does not penalize the untransformed part of the input phrase. Therefore, another heuristic can be designed that takes into consideration the upper bound of the transformation probability p(c→q). This can be written formally as follows:

$${heuristic}^{*} ( π ) = {max}_{c {∈}_{π} \cdot Node \cdot Queries} p ( c ) \times {max}_{{c}^{′}} p ( {c}^{′} \to {q}_{[ π , Pos , \vert q \vert ]} \vert π \cdot Hist ; Θ ) \qquad ( 18 )$$

where q_{[π·Pos,|q|]} is the substring of q from position π·Pos to |q|. For each query, the second maximization in the equation can be computed for all positions of q using dynamic programming, for instance.

The A* algorithm utilized by the search component 106 can also be configured to perform exact match for off-line spelling correction by substituting the probabilities in line W with line K. Accordingly, transformations involving additional unmatched letters can be penalized even after finding a prefix match.

It may be worth noting that a search path can theoretically grow to infinite length, as ε is allowed to appear as either the source or target of a character sequence. In practice, this does not happen as the probability of such transformation sequences will be very low and will not be further expanded in the search algorithm utilized by the search component 106.

A transformation model with larger L parameter significantly increases the number of potential search paths. As all possible character sequences with length less than or equal to L are considered when expanding each path, transformation models with larger L are less efficient.

Since the search component 106 is configured to return possible spelling corrections and phrase completions as the user 104 provides input to the online spell correction/phrase completion system 100, it may be desirable to limit the search space such that the search component 106 does not consider unpromising paths. In practice, beam pruning methods can be employed to achieve significant improvement in efficiency without causing a significant loss in accuracy. Two exemplary pruning techniques that can be employed are absolute pruning and relative pruning, although other pruning techniques may be employed.

In absolute pruning, a number of paths to be explored at each position in the target query q can be limited. As mentioned previously, the complexity of the aforementioned search algorithm is previously unbounded due to ε transfemes. By applying absolute pruning, however, the complexity of the algorithm can be bound by O(|q|LK), where K is the number of paths allowed at each position in q.

In relative pruning, only the paths that have probabilities higher than a certain percentage of the maximum probability at each position are explored by the search component 106. Such threshold values can be carefully designed to achieve substantially optimal efficiency without causing a significant drop in accuracy. Furthermore, the search component 106 can make use of both absolute pruning and relative pruning (as well as other pruning techniques) to improve search efficiency and accuracy.

In addition, while the search component 106 may be configured to always provide a top threshold number of spell correction/phrase completion suggestions to the user 104, in some instances it may not be desirable to provide to the user 104 with a predefined number of suggestions for every query proffered by the user 104. For instance, showing more suggestions to the user 104 incurs a cost, as the user 104 will spend more time looking through suggestions instead of completing her task. Additionally, displaying irrelevant suggestions may annoy the user 104. Therefore, a binary decision can be made for each phrase completion/suggestion on whether it should be shown to the user 104. For instance, the distance between the target query q and a suggested correction c can be measured, wherein the larger the distance, the greater the risk that providing the suggested correction to the user 104 will be undesirable. An exemplary manner to approximate the distance is to compute the log of the inverse transformation probability, averaged over the number of characters in the suggestion. This can be shown as follows:

$$risk ( c , q ) = \frac{1}{\vert q \vert} log \frac{1}{p ( c \to q )} \qquad ( 19 )$$

This risk function may not be incredibly effective in practice, however, as the input query q may comprise several words, of which only one is misspelled. It is not intuitive to average the risk over all letters in the query. Instead, the query q can be segmented into words and the risk can be measured at the word level. For example, the risk of each word can be measured separately using the above formula, and the final risk function can be defined as a fraction of words in q having a risk value above a given threshold. If the search component 106 determines that the risk of providing a suggested correction/completion is too great, then the search component 106 can fail to provide such suggested correction/completion to the user.

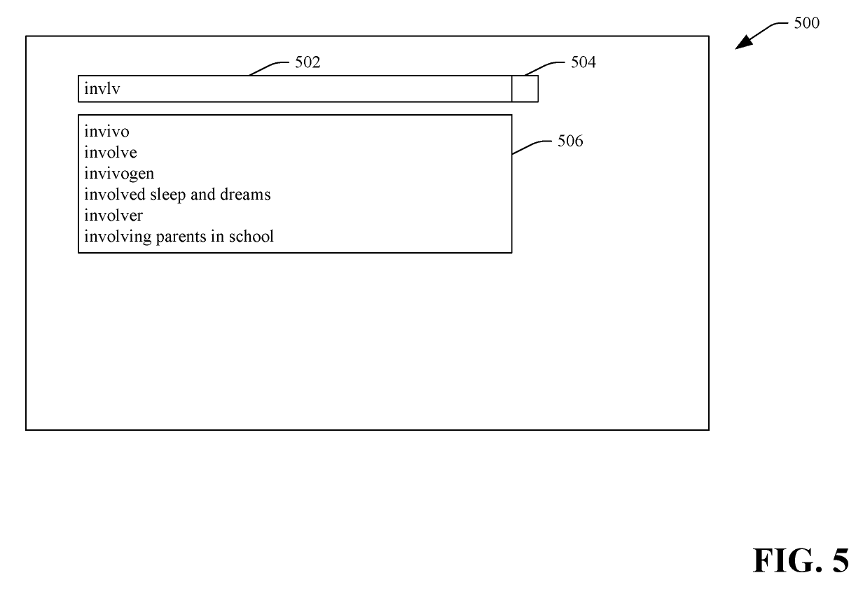

Turning now to FIG. 5, an exemplary graphical user interface 500 corresponding to a search engine is illustrated. The graphical user interface 500 includes a text entry field 502, wherein the user can proffer a query that is to be provided to the search engine. A button 504 may be shown in graphical relation to the text entry field 502, wherein depression of the button 504 causes the query entered into the text entry field 502 to be provided to the search engine (finalized by the user). A query suggestion field 506 can be included, wherein the query suggestion field 506 includes suggested queries based upon the query prefix that has been entered by the user. As shown, the user has entered the query prefix “invlv”. This query prefix can be received by the online spell correction/phrase completion system 100, which can correct the spelling in the potentially misspelled phrase prefix and provide most likely query completions to the user. The user may then utilize a mouse to select one of the query suggestions/completions for provision to the search engine. These query suggestions include properly spelled words which can improve performance of the search engine.

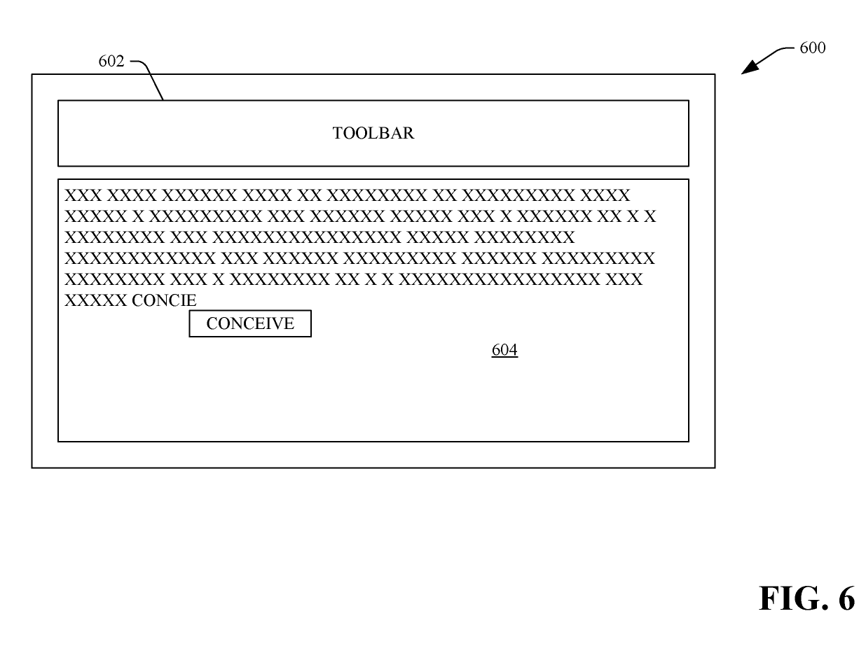

Referring now to FIG. 6, another exemplary graphical user interface 600 is illustrated. This graphic user interface 600 can correspond to a word processing application, for instance. The graphical user interface 600 includes a toolbar 602 that may comprise a plurality of selectable buttons, pull down menus or the like, wherein individual buttons or possible selections correspond to certain word processing tasks such as font selection, text size, formatting, and the like. The graphical user interface 600 further comprises a text entry field 604, where the user can compose text and images, etc. As can be shown, the text entry field 604 comprises text that was entered by the user. As a user types, spelling corrections can be presented to the user through utilization of the online spell correction/phrase completion system 100. For instance, the user has typed the letters “concie” into the text entry field. In an example corresponding to the word processing system, this word/phrase prefix can be provided to the online spell correction/phrase completion system 100, which can present the user 104 with a most probable corrected spelling suggestion. The user may utilize a mouse pointer to select for such suggestion, which can replace the text that was previously entered by the user.

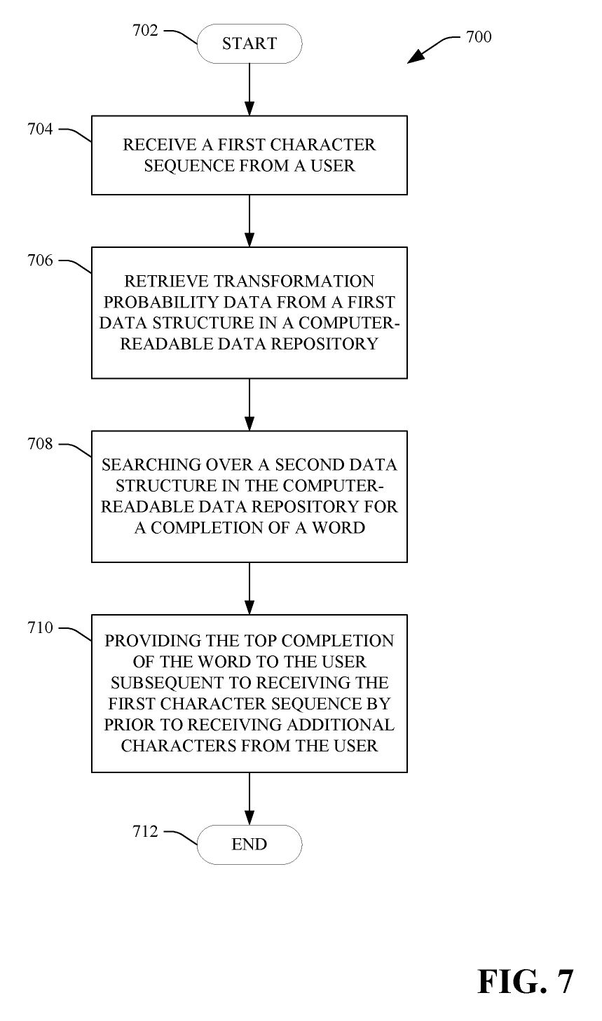

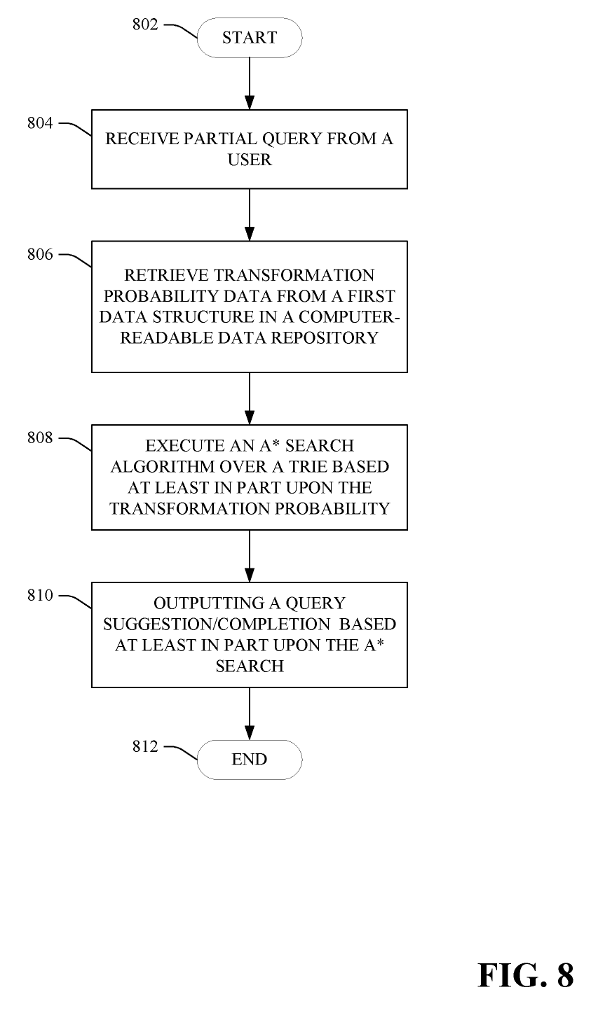

With reference now to FIGS. 7 and 8, various exemplary methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like. The computer-readable medium may be a non-transitory medium, such as memory, hard drive, CD, DVD, flash drive, or the like.

With reference now to FIG. 7, an exemplary methodology 700 that facilitates performing online spelling correction/phrase completion is illustrated. The methodology 700 starts at 702, and at 704 a first character sequence is received from a user. Such first character sequence may be a portion of a phrase prefix that is provided to a computer-executable application. At 706, transformation probability data is retrieved from a first data structure in a computer readable data repository. For example, the first data structure may be a computer executable transformation model that is configured to receive the first character sequence (as well as other character sequences in a phrase prefix that includes the first character sequence) and outputs a transformation probability for the first character sequence. This transformation probability indicates a probability that a second character sequence has been transformed into the first character sequence. For instance, the second character sequence may be a properly spelled portion of a word, while the first character sequence is an improperly spelled portion of such word that corresponds to the properly spelled portion of the word.

At 708, a second data structure is searched over in the computer readable data repository for a completion of a word or phrase. This search can be performed based at least in part upon the transformation probability retrieved at 706. As mentioned previously, the second data structure in the computer readable data repository may be a trie, an n-gram language model, or the like.

At 710, a top threshold number of completions of the word or phrase are provided to the user subsequent to receiving the first character sequence, but prior to receiving additional characters from the user. In other words, the top completions of the word or phrase are provided to the user as an online spelling correction/phrase completion suggestions. The methodology 700 completes at 712.

With reference now to FIG. 8, another exemplary methodology 800 that facilitates performing a query spelling correction/completion is illustrated. The methodology 800 starts at 802, and at 804 a query prefix is received from a user, wherein the query prefix comprises a first character sequence.

At 806, responsive to receiving the query prefix, transformation probability data is retrieved from a first data structure, wherein the transformation probability data indicates a probability that the first character sequence is a transformation of a properly spelled second character sequence. At 808, subsequent to retrieving the transformation probability data, an A* search algorithm is executed over a trie based at least in part upon the transformation probability data. As discussed above, the trie comprises a plurality of nodes and paths, where leaf nodes in the trie represent possible query completions and intermediate nodes represent character sequences that are portions of query completions. Each intermediate node in the trie has a value assigned thereto that is indicative of a most probable query completion given a query sequence that reaches the intermediate node that is assigned the value.

At 810, a query suggestion/completion is output based at least in part upon the A* search. This query suggestion/completion can include a spelling correction of a misspelled word or a partially misspelled word in a query proffered by the user. The methodology 800 completes at 812.

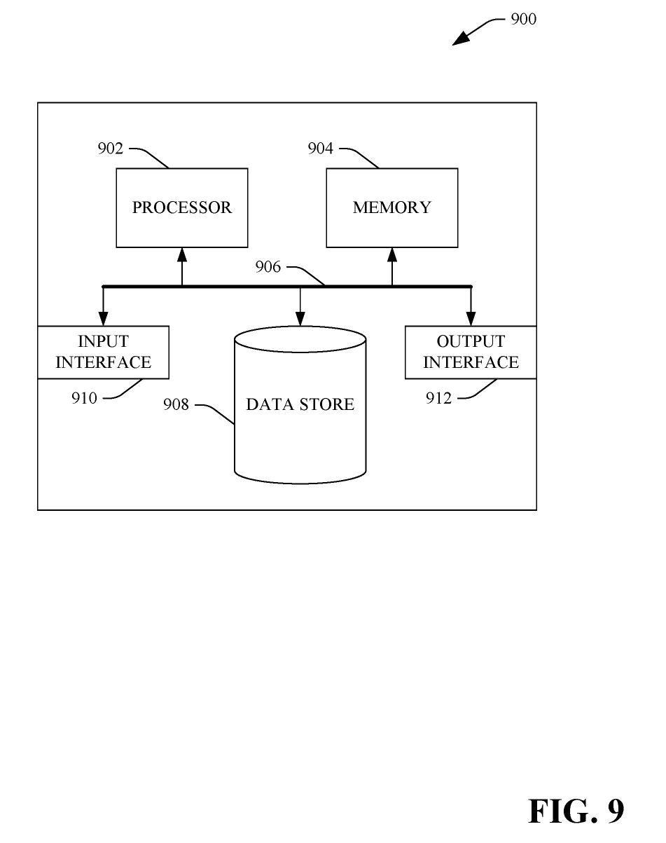

Now referring to FIG. 9, a high-level illustration of an exemplary computing device 900 that can be used in accordance with the systems and methodologies disclosed herein is illustrated. For instance, the computing device 900 may be used in a system that supports performance of online spelling correction/phrase completion. In another example, at least a portion of the computing device 900 may be used in a system that supports building data structures described above. The computing device 900 includes at least one processor 902 that executes instructions that are stored in a memory 904. The memory 904 may be or include RAM, ROM, EEPROM, Flash memory, or other suitable memory. The instructions may be, for instance, instructions for implementing functionality described as being carried out by one or more components discussed above or instructions for implementing one or more of the methods described above. The processor 902 may access the memory 904 by way of a system bus 906. In addition to storing executable instructions, the memory 904 may also store a trie, an n-gram language model, a transformation model, etc.

The computing device 900 additionally includes a data store 908 that is accessible by the processor 902 by way of the system bus 906. The data store may be or include any suitable computer-readable storage, including a hard disk, memory, etc. The data store 908 may include executable instructions, a trie, a transformation model, etc. The computing device 900 also includes an input interface 910 that allows external devices to communicate with the computing device 900. For instance, the input interface 910 may be used to receive instructions from an external computer device, from a user, etc. The computing device 900 also includes an output interface 912 that interfaces the computing device 900 with one or more external devices. For example, the computing device 900 may display text, images, etc. by way of the output interface 912.

Additionally, while illustrated as a single system, it is to be understood that the computing device 900 may be a distributed system. Thus, for instance, several devices may be in communication by way of a network connection and may collectively perform tasks described as being performed by the computing device 900.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices. Furthermore, a component or system may refer to a portion of memory and/or a series of transistors.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A computing system that is configured to update a search engine graphical user interface (GUI), the computing system comprising:
a processor; and
memory storing instructions that, when executed by the processor, cause the processor to perform acts comprising:
receiving, from a client computing device that is in network communication with the computing system, a first sequence of characters, wherein each character in the first sequence of characters is received as each character is input by a user of the client computing device in a text entry field of the search engine GUI displayed at the client computing device, and further wherein the first sequence of characters includes a last character;
immediately responsive to receiving the last character in the first sequence of characters, and prior to receiving further input based upon interaction of the user with the search engine GUI, identifying that a word, when misspelled, includes the first sequence of characters;
immediately responsive to receiving the last character in the first sequence of characters, and prior to receiving further input based upon interaction of the user with the search engine GUI, identifying that the word, when properly spelled, includes a second sequence of characters in place of the first sequence of characters, wherein the word, when properly spelled, includes a character that follows the second sequence of characters, and further wherein the second sequence of characters is different from the first sequence of characters;
responsive to identifying that the word, when properly spelled, includes the second sequence of characters in place of the first sequence of characters, identifying a phrase that comprises the word followed by a second word; and
responsive to identifying the phrase, causing the search engine GUI to be updated to include a window that comprises the phrase, wherein the phrase is selectable in the window, and further wherein the word displayed in the window is properly spelled.

2. The computing system of claim 1, the acts further comprising:
receiving, from the client computing device, an indication that the phrase displayed in the window on the search engine GUI has been selected by the user;
using the phrase as a query, obtaining search results; and
responsive to obtaining the search results, causing the search engine GUI to be updated to depict the search results.

3. The computing system of claim 1, wherein the phrase comprises a third word that precedes the word.

4. The computing system of claim 1, wherein identifying that the word, when misspelled, includes the first sequence of characters comprises:
retrieving transformation probability data from a first data structure in a computer-readable data repository that is accessible to the processor, the transformation probability data is indicative of a probability that the user improperly transformed the second sequence of characters to the first sequence of characters.

5. The computing system of claim 4, wherein identifying the phrase that comprises the word followed by the second word comprises:
responsive to retrieving the transformation probability data, searching over a second data structure that is accessible to the processor, the second data structure comprises multi-word phrases, the phrase included in the multi-word phrases, wherein searching over the second data structure comprises:
identifying the second sequence of characters based upon the transformation probability data; and
identifying the phrase based upon the second sequence of characters.

6. The computing system of claim 5, wherein the second data structure is an n-gram language model.

7. The computing system of claim 5, wherein the second data structure is a trie that maps phrases represented in the trie to probabilities that the user intends to input the phrases to the search engine.

8. The computing system of claim 1, wherein the client computing device is a mobile telephone.

9. The computing system of claim 1, the acts further comprising:
computing a risk that the phrase is not germane to an information retrieval intent of the user when the user set forth the first sequence of characters;
comparing the risk with a threshold value; and
causing the GUI to be updated to include the phrase in the window only responsive to determining that the risk is below the threshold value.

10. The computing system of claim 1, wherein a number of characters in the first sequence of characters is greater than two.

11. The computing system of claim 1, wherein a number of characters in the first sequence of characters is different from a number of characters in the second sequence of characters.

12. The computing system of claim 1, wherein a number of characters in the first sequence of characters is equivalent to a number of characters in the second sequence of characters.

13. A client computing device that is in network communication with a server computing device, wherein the client computing device is configured to update a graphical user interface (GUI) of a search engine based upon data received from the server computing device, the client computing device comprising:
a display;
memory; and
a processor that is operably coupled to the display and the memory, wherein the memory has instructions stored therein that, when executed by the processor, cause the processor to perform acts comprising:
receiving, from a user of the client computing device and by way of a query field in the search engine GUI displayed on the display, a first sequence of characters;
transmitting, to the server computing device, each character in the first sequence of characters as each character is received;
subsequent to transmitting a last character in the first sequence of characters and prior to receiving any additional input from the user, receiving a phrase from the server computing device, wherein the phrase comprises a first word followed by a second word, and further wherein the first word includes a second sequence of characters in place of the first sequence of characters, wherein the first word is misspelled when the first word includes the first sequence of characters and the first word is properly spelled when the first word includes the second sequence of characters;
responsive to receiving the phrase, updating the GUI of the search engine on the display to include a window that comprises the phrase, wherein the phrase is selectable in the window.

14. The client computing device of claim 13 being a mobile telephone.

15. The client computing device of claim 13, the acts further comprising:
responsive to receiving an indication that the phrase in the window has been selected by the user, transmitting the phrase to the server computing device, wherein the server computing device generates search results based upon the query;
receiving the search results from the server computing device; and
further updating the GUI of the search engine on the display to depict the search results.

16. The client computing device of claim 13, wherein a number of characters in the first sequence of characters is different from a number of characters in the second sequence of characters.

17. The client computing device of claim 13, wherein a number of characters in the first sequence of characters is greater than two.

18. The client computing device of claim 13, wherein the window includes several phrases, each phrase in the several phrases comprises the first word.

19. A method for causing a graphical user interface (GUI) of a search engine to be updated at a client computing device, the method performed by a server computing device that is in network communication with the search engine, the method comprising:
receiving, from the client computing device, a first sequence of characters, wherein each character in the first sequence of characters is received as each character is input by a user of the client computing device in a query field of the search engine GUI, and further wherein the first sequence of characters includes a last character;
immediately responsive to receiving the last character in the first sequence of characters, and prior to receiving further input based upon interaction of the user with the search engine GUI, identifying that a word, when misspelled, includes the first sequence of characters;
immediately responsive to receiving the last character in the first sequence of characters, and prior to receiving further input based upon interaction of the user with the search engine GUI, identifying that the word, when properly spelled, includes a second sequence of characters in place of the first sequence of characters, wherein the word, when properly spelled, includes a character that follows the second sequence of characters, and further wherein the second sequence of characters is different from the first sequence of characters;
responsive to identifying that the word, when properly spelled, includes the second sequence of characters in place of the first sequence of characters, identifying a phrase that comprises the word followed by a second word; and
responsive to identifying the phrase, causing the search engine GUI to be updated to include a window that comprises the phrase, wherein the phrase is selectable in the window, and further wherein the word displayed in the window is properly spelled.

20. The method of claim 19, wherein identifying that the word, when misspelled, includes the first sequence of characters comprises:
retrieving transformation probability data from a first data structure in a computer-readable data repository that is accessible to the processor, the transformation probability data is indicative of a probability that the user improperly transformed the second sequence of characters to the first sequence of characters.
